(19) United States
(12) Patent Application Publication
(10) Pub. No.: US 2010/0169929 A1
(43) Pub. Date: Jul. 1, 2010

(54) METHOD FOR PROVIDING ELECTRONIC PROGRAM GUIDE INFORMATION AND SYSTEM THEREOF

(76) Inventors: Jung yi Choi, Gyeonggi-do (KR); Han jo Jung, Gyeonggi-do (KR)

Correspondence Address: JUNEAU PARTNERS, 333 N Fairfax St., Suite 305, ALEXANDRIA, VA, 22301, US

(21) Appl. No.: 12/293,593

(22) PCT Filed: Mar. 13, 2007
(86) PCT No.: PCT/KR07/01208

§ 371 Date: Sep. 19, 2008

(30) Foreign Application Priority Data
Mar. 23, 2006 (KR) 10-2006-0026712

(51) Int. Cl. H04N 5/445; H04N 5/50

(52) U.S. Cl. 725/53; 725/54; 348/731; 348/E05.097

(57) ABSTRACT

An electronic program guide (EPG) information providing method and an EPG information providing system are provided. In the EPG information providing system, a first transport stream including first EPG information is received via a channel selected from a plurality of channels, and the first EPG information is extracted from the received transport stream. The reception channel selected from the plurality of channels is automatically changed in response to a predetermined channel selection signal. A second transport stream which is input via each changed channel and includes second EPG information is received, and the second EPG information is extracted from the second transport stream and stored. A keyword is generated on the basis of received EPG information, and additional information is generated by searching for the keyword using a predetermined search server and transmitted to a viewer.

### TECHNICAL FIELD

The present invention relates to a method and system for providing a variety of electronic program guide (EPG) information such as broadcasting channel information and broadcasting program information which are transmitted with being included in service information of digital broadcasting. More specifically, the present invention relates to a method of automatically collecting EPG information for all channels, a method of transmitting the collected EPG information to a user, and a system capable of performing these methods. The present invention also relates to a method and system for extracting a keyword from EPG information and transmitting information corresponding to the extracted keyword together with EPG information from an Internet search server to a user set top box.

### BACKGROUND ART

Examples of general digital broadcasting include digital satellite broadcasting, digital cable broadcasting, digital terrestrial broadcasting, etc. A digital broadcasting receiver, such as a set top box (STB) for receiving such digital broadcasting, receives a digital broadcasting signal of an MPEG transport stream, recovers a video signal and an audio signal from the digital broadcasting signal, and transmits the video and audio signals to a display device (such as, a TV or a monitor) so that a viewer can watch a desired broadcasting program.

An electronic program guide (EPG) denotes a kind of a broadcasting program schedule which is displayed on the screen of a digital TV through data broadcasting that uses an empty frequency band or an extra channel. The EPG includes information such as program channels, transponder numbers, broadcasting hours, titles, categories, etc. A viewer can ascertain what broadcasting programs are to be on air not only on the day but also, for example, about one week after the day, and on which broadcasting stations the broadcasting programs are on air, by manipulating a remote controller.

As digital broadcasting is executed in terrestrial, cable, and satellite broadcasting, the number of channels that a user can watch greatly increases compared with existing analog broadcasting, and the use of channels is not fixed but the number of channels or the allocation of channels dynamically varies. Thus, the EPG helping a viewer to select a suitable broadcasting program is being recognized as an essential function and becomes an important differentiation item of digital broadcasting.

However, in digital broadcasting where a broadcasting station transmits a broadcasting stream including only EPG information of its channel and an enormous number of, namely, about 1000, channels are anticipated to be provided, a viewer should obtain EPG information for all channels by changing all of the channels one by one. In addition, the EPG information obtained in this way varies according to the circumstances of a broadcasting station, thus damaging the reliability of the EPG information. Therefore, special companies that provide EPG information are created.

However, it is inefficient for these special companies to collect EPG information, and these special companies fail to provide not only the information included in the EPG information but also detailed information associated with the information.

### DISCLOSURE OF INVENTION

### Technical Problem

The present invention provides an electronic program guide (EPG) information providing method and system in which EPG information is automatically collected and provided to a viewer, or a set top box (STB) including the EPG information providing system.

The present invention also provides a method and system for extracting an important keyword from EPG information in which a user can take an interest, searching for information related to the keyword using a search server connected to the Internet, and transmitting the result of the search together with the EPG information to a viewer.

### Advantageous Effects

As described above, in an EPG information providing method and system according to the present invention, EPG information can be efficiently collected, and additional information in addition to the EPG information transmitted by a broadcasting station is sent to a user so that the user can know more enormous information and more detailed information regarding information about broadcasting programs. Moreover, related information about a matter of interest of a viewer as well as information about broadcasting itself can be easily obtained from a program guide displayed on the screen of a display device, without efforts such as a search through other media.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an electronic program guide (EPG) information providing system according to an embodiment of the present invention;

FIG. 2 is a block diagram of an EPG information providing system according to another embodiment of the present invention;

FIG. 3 is a block diagram of a user set top box including the EPG information providing system illustrated in FIG. 1, according to an embodiment of the present invention;

FIG. 4 is a block diagram of an extended EPG information providing system according to an embodiment of the present invention;

FIG. 5 is a conventional EPG screen;

FIG. 6 is an EPG screen according to an embodiment of the present invention; and

FIG. 7 is an EPG screen displayed when an item on the EPG screen of FIG. 6 is selected.

### BEST MODE FOR CARRYING OUT THE INVENTION

According to an aspect of the present invention, there is provided an electronic program guide (EPG) information providing method including the operations of: receiving a transport stream including EPG information via a channel selected from a plurality of channels; extracting the EPG information from the received transport stream and storing the EPG information; sequentially changing a reception channel selected from the plurality of channels; and receiving a transport stream which is input via each sequentially-changed channel and includes corresponding EPG information, extracting the corresponding EPG information from the transport stream, and storing the extracted EPG information.

The EPG information providing method further includes the operation of transmitting the stored EPG information to a user set top box.

According to another aspect of the present invention, there is provided an EPG information providing system including a tuner, a tuner control unit, an EPG information extraction module, and a storage device for receiving and storing extracted EPG information. The tuner control unit outputs a channel selection signal. The tuner sequentially selects a reception channel from a plurality of channels in response to the channel selection signal and receives a transport stream which is input via each sequentially-changed channel and includes EPG information.

The EPG information extraction module is connected to the tuner and extracts the EPG information from the transport stream input via the each sequentially-changed channel. The storage device receives and stores the EPG information extracted by the EPG information extraction module. The EPG information providing system further includes a network module for transmitting the stored EPG information pieces to a user set top box.

According to another aspect of the present invention, there is provided an extended EPG information providing method including the operations of: receiving EPG information extracted from a transport stream and storing the EPG information in database, using a first server; generating a keyword on the basis of the received EPG information and storing the keyword in the database, using the first server; transmitting the keyword to a predetermined search server, using the first server; and receiving a result of a search performed by the search server and extracting additional information from the search result, using the first server.

The extended EPG information providing method may further include the operation of transmitting at least one of the EPG information and the additional information to a user set top box using the first server. In the operation of generating the keyword, the keyword may be extracted from at least one of program titles, program genres, and program descriptions that are included in the EPG information.

In the operation of extracting the additional information, the additional information may be extracted using predetermined criteria including at least one of a date when the search result is written, a search ranking obtained in a search server, an appearance frequency included in the search result, and a category.

The additional information may be any type of information, such as a picture, a text, a voice, or a moving picture and may be any of the information included in the result of the search using the keyword.

According to another aspect of the present invention, there is provided an extended EPG information providing system including a keyword management module, an additional information generation module, a database, and a network module.

The keyword management module receives EPG information extracted from a transport stream, stores the EPG information in the database, extracts a keyword on the basis of the EPG information, and stores the extracted keyword in the database.

The additional information generation module transmits the extracted keyword to a predetermined search server, receives a result of search performed by the search server, and extracts additional information from the search result. The database stores the EPG information, the keyword, and the additional information. The network module transmits at least one of the EPG information stored in the database and the additional information to a user set top box.

The keyword management module extracts the keyword from at least one of program titles, program genres, and program descriptions that are included in the EPG information.

The additional information generation module includes an additional information search module for transmitting the generated keyword to the predetermined search server and receiving the result of the search performed by the search server, and an additional information extraction module for extracting the additional information from the search result and storing the extracted additional information in the database.

The additional information extraction module extracts the additional information according to criteria including at least one of a date when the search result is written, a search ranking obtained in a search server, an appearance frequency included in the search result, and a category.

### Mode for the Invention

The attached drawings for illustrating preferred embodiments of the present invention are referred to in order to gain a sufficient understanding of the present invention, the merits thereof, and the objectives accomplished by the implementation of the present invention. Hereinafter, the present invention will be described in detail by explaining preferred embodiments of the invention with reference to the attached drawings. Like reference numerals in the drawings denote like elements.

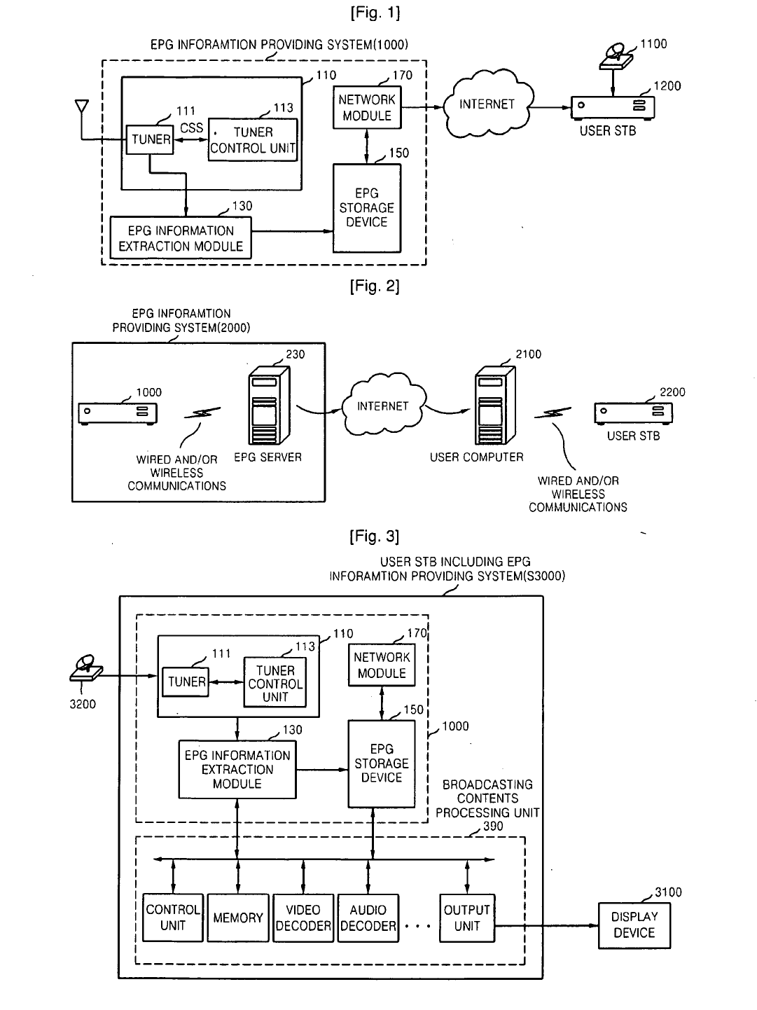

FIG. 1 is a block diagram of an electronic program guide (EPG) information providing system 1000 according to an embodiment of the present invention. Referring to FIG. 1, the EPG information providing system 1000 includes a tuner 111, a tuner control unit 113 which outputs a channel selection signal CSS to the tuner 111, an EPG information extraction module 130 which extracts EPG information from a transport stream, and an EPG storage device 150 which stores the EPG information. The EPG information providing system 1000 may further include a network module 170 which transmits the EPG information to a user set top box (STB) 1100.

The tuner 111 receives a first transport stream via a channel selected from a plurality of channels. The first transport stream may be received via a satellite antenna in case of digital satellite broadcasting, or may be received via a broadcasting input terminal in case of cable or terrestrial broadcasting.

The EPG information extraction module 130 extracts first EPG information from the first transport stream output by the tuner 111 and stores the first EPC information in the EPG storage device 150. The tuner control unit 113 outputs the channel selection signal CSS to the tuner 111, and the tuner 111 changes a reception channel in response to the channel selection signal CSS. The channel selection signal CSS may be a signal for sequentially selecting channels or a signal for randomly selecting a channel from unselected channels. However, it is preferable to select the channels at least once for each of the channels.

When the reception channel of the tuner 111 is changed in response to the channel selection signal CSS, the tuner 111 receives a second transport stream via a changed reception channel and transmits the second transport stream to the EPG information extraction module 130. The EPG information extraction module 130 extracts second EPG information from the second transport stream and stores the second EPG information in the EPG storage device 150.

The EPG storage device 150 may be a volatile memory, a non-volatile memory, a disk storage device, or database for storing EPG information. However, the present invention is not limited to these examples.

The network module 170 may have an IP address and transmit the EPG information stored in the EPG storage device 150 to the user STB 1100 directly via the Internet or via an EPG server connected to the Internet. A user may select a broadcasting on the basis of received EPG information. In case of digital satellite broadcasting, the user receives and watches a broadcasting selected via a satellite antenna 1200.

An EPG information providing system according to the present invention may include a separate EPG server as in the embodiment illustrated in FIG. 2, or may be included in a user STB as in the embodiment illustrated in FIG. 3.

FIG. 2 is a block diagram of an EPG information providing system 2000 according to another embodiment of the present invention. Referring to FIG. 2, the EPG information providing system 2000 includes an EPG collecting STB 1000 and an EPG server 230 for providing EPG services.

The EPG collecting STB 1000 includes the tuner 111, the tuner control unit 113, the

EPG information extraction module 130, the EPG storage device 150, and the network module 170 which are included in the EPG information providing system 1000 of FIG. 1. The EPG collecting STB 1000 transmits EPG information to the EPG server 230 via a wired and/or wireless communications network, and the EPG server 230 transmits the EPG information to a user computer 2100 via the Internet. The user computer 2100 transmits the EPG information to a user STB 2200 via a wired and/or wireless communications network. When the user STB 2200 can be directly connected to the Internet, the EPG information may be transmitted directly to the user STB 2200 from the EPG server 230.

FIG. 3 is a block diagram of a user STB 3000 including the EPG information providing system 1000 illustrated in FIG. 1, according to an embodiment of the present invention. Referring to FIG. 3, the user STB 3000 includes a broadcasting contents processing unit 390 and the EPG information providing system 1000 illustrated in FIG. 1. The broadcasting contents processing unit 390 may be a general digital broadcasting STB. In case of digital satellite broadcasting, the broadcasting contents processing unit 390 receives a digital broadcasting signal of a transport stream received via a satellite antenna 3200, recovers and processes the original video and audio signals from the digital broadcasting signal, and outputs the video and audio signals to a display device 3100 so that a user can watch a desired broadcasting program. Like not only a general TV but also a variety of monitors, the display device 3100 can reproduce an image.

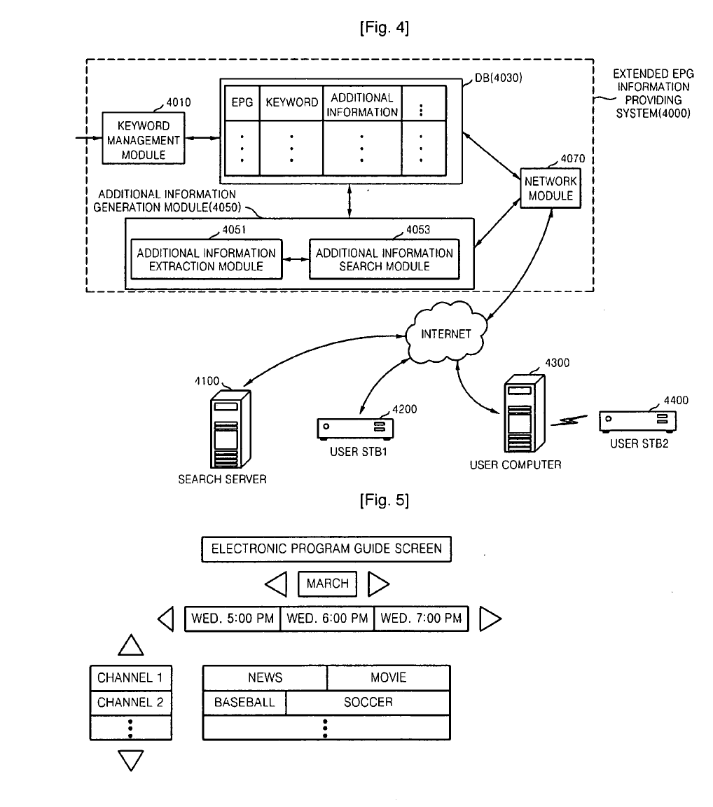

FIG. 4 is a block diagram of an extended EPG information providing system 4000 according to an embodiment of the present invention. Referring to FIG. 4, the extended EPG information providing system 4000 includes a keyword management module 4010, an additional information generation module 4050, database 4030, and a network module 4070. The extended EPG information providing system 4000 generates a keyword on the basis of received EPG information, transmits the keyword to a search server 4100, and generates additional information from information found by the search server 4100.

More specifically, the keyword management module 4010 receives EPG information extracted from a transport stream, stores the EPG information in the database 4030, and generates a keyword on the basis of the EPG information. The EPG information may be received from the EPG information providing system 1000 of FIG. 1. Also, the keyword management module 4010 extracts a keyword from the EPG information and stores the keyword in the database 4030. The keyword is extracted from all of the text information included in the EPG information, for example, from not only a program title but also a program genre, a program description, etc., which are included in the EPG information. In other words, a viewer can obtain maximally accurate and enormous information about broadcasting programs.

The additional information generation module 4050 transmits the keyword to the search server 4100. The additional information generation module 4050receives information searched on the basis of the keyword by the search server 4100 and generates additional information from the received information. The additional information generation module 4050 may include an additional information extraction module 4051 and an additional information search module 4053. The additional information search module 4053 transmits the keyword to the search server 4100 and receives a result of the search performed by the search server 4100. The additional information extraction module 4051 extracts additional information from the result of the search and stores the extracted additional information in the database 4030. The additional information may be extracted using at least one of criteria, such as a date when the search result is written, a search ranking obtained in the search server 4100, an appearance frequency included in the search result, and a category. The extracted additional information is not limited to a particular form as long as being included in the search result, such as a picture, a text, a voice, or a moving picture. The search server 4100 may be a commonly used search engine provided by the Internet, such as Naver, Google, or Daum. In order to enormously and professionally search for broadcasting information, the search server 4100 may be independently established.

The database 4030 stores the EPG information, the keyword, and/or the additional information. These information pieces may be stored in the form of a single table or different tables. Alternatively, these information pieces may be stored in various forms, such as, a linked-list, a tree, a relational database, etc.

The network module 4070 transmits a keyword received from the additional information search module 4053 to the search server 4100, receives a search result from the search server 4100, and transmit the received search result to the additional information search module 4053 or transmit the EPG information, the additional information, etc. stored in the database 4030 to the user STB 4200 or the user computer 4300. A user may receive the EPG information, the additional information, etc. stored in the database 4030 in a user STB 4400 via the user computer 4300.

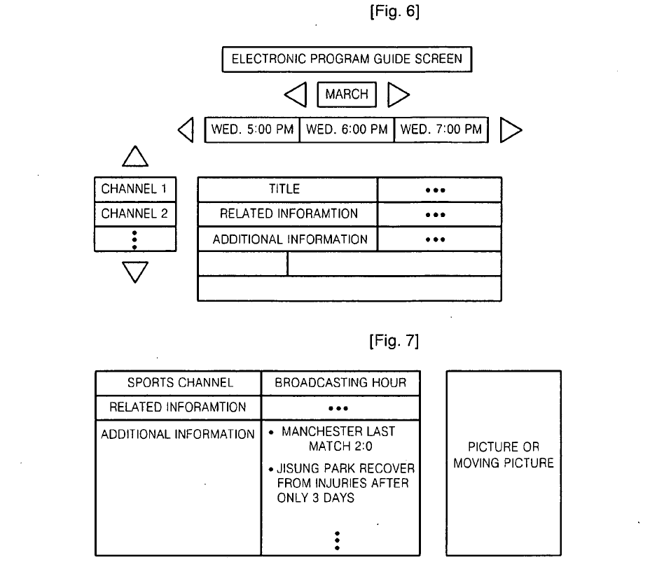

FIG. 5 is a conventional EPG screen. FIG. 6 is an EPG screen according to an embodiment of the present invention. FIG. 7 is an EPG screen displayed when a user selects an item on the EPG screen of FIG. 6. Referring to FIG. 6, additional information generated according to the present invention is displayed on the EPG screen. A user can ascertain more enormous and accurate information about broadcasting programs from the additional information. The user selects a program in order to view more detailed information. In this case, a screen as illustrated in FIG. 7 is displayed. Referring to FIG. 7, when displayed detailed additional information includes information such as a video, an audio, a picture, etc. instead of a text, a window for playing back the detailed additional information is also displayed.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments fur accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

An EPG information providing method and system according to the present invention may be used in a digital broadcasting set top box.

1. An EPG (electronic program guide) information providing method comprising:
receiving a transport stream including EPG information via a channel selected from a plurality of channels; extracting the EPG information from the received transport stream and storing the EPG information; sequentially changing a reception channel selected from the plurality of channels; and receiving a transport stream which is input via each sequentially-changed channel and includes corresponding EPG information, extracting the corresponding EPG information from the transport stream, and storing the extracted EPG information.

2. The EPG information providing method of claim 1, further comprising transmitting the stored EPG information to a user set top box.

3. An EPG information providing system comprising: a tuner control unit outputting a channel selection signal; a tuner sequentially selecting a reception channel from a plurality of channels in response to the channel selection signal and receiving a transport stream which is input via each sequentially-changed channel and includes EPG information; an EPG information extraction module connected to the tuner, extracting the EPG information from the transport stream input via the each sequentially- changed channel; and a storage device receiving and storing the EPG information extracted by the EPG information extraction module.

4. The EPG information providing system of claim 3, further comprising a network module transmitting the stored EPG information to a user set top box.

5. An EPG information providing method comprising: receiving EPG information extracted from a transport stream and storing the
EPG information in database, using a first server; generating a keyword on the basis of the received EPG information and storing the keyword in the database, using the first server; transmitting the keyword to a predetermined search server, using the first server; and receiving a result of a search performed by the search server and extracting additional information from the search result, using the first server.

6. The EPG information providing method of claim 5, further comprising transmitting at least one of the EPG information and the additional information to a user set top box using the first server.

7. The EPG information providing method of claim 5, wherein in the generating of the keyword, the keyword is extracted from at least one of program titles, program genres, and program descriptions that are included in the EPG information.

8. The EPG information providing method of claim 5, wherein in the extracting of the additional information, the additional information is extracted using predetermined criteria including at least one of a date when the search result is written, a search ranking obtained in a search server, an appearance frequency included in the search result, and a category.

9. The EPG information providing method of claim 5, wherein the additional information comprises at least one of a picture, a text, a voice, and a moving picture.

10. An EPG information providing system comprising: a database; a keyword management module receiving EPG information extracted from a transport stream, storing the EPG information in the database, extracting a keyword on the basis of the EPG information, and storing the extracted keyword in the database; an additional information generation module transmitting the extracted keyword to a predetermined search server, receiving a result of search performed by the search server, and extracting additional information from the search result; and a network module transmitting at least one of the EPG information stored in the database and the additional information to a user set top box.

11. The EPG information providing system of claim 10, wherein the keyword management module extracts the keyword from at least one of program titles, program genres, and program descriptions that are included in the EPG information.

12. The EPG information providing system of claim 10, wherein the additional information generation module comprises: an additional information search module transmitting the generated keyword to the predetermined search server and receiving the result of the search perfonned by the search server; and an additional information extraction module extracting the additional information from the search result and storing the extracted additional information in the database.

13. The EPG information providing system of claim 12, wherein the additional information extraction module extracts the additional information according to criteria including at least one of a date when the search result is written, a search
ranking obtained in a search server, an appearance frequency included in the search result, and a category.

14. The EPG information providing system of claim 10, wherein the additional information comprises at least one of a picture, a text, a voice, and a moving picture.

15. A recording medium having embodied thereon a program for the method of claim 1.

16. A recording medium having embodied thereon a program for the method of claim 2.

17. A recording medium having embodied thereon a program for the method of claim 5.

18. A recording medium having embodied thereon a program for the method of claim 6.

19. A recording medium having embodied thereon a program for the method of claim 7.

20. A recording medium having embodied thereon a program for the method of claim 8.

21. A recording medium having embodied thereon a program for the method of claim 9.
